(19) United States
(12) Patent Application Publication
(10) Pub. No.: US 2002/0107139 A1
(43) Pub. Date: Aug. 8, 2002

(54) Encapsulated hydrogenation catalysts with controlled dispersion and activity

(76) Inventors: Thomas F. Degnan, Moorestown, NJ (US); Ivy Dawn Johnson, Lawrenceville, NJ (US)

Correspondence Address: EXXONMOBIL RESEARCH AND ENGINEERING COMPANY, (formerly Exxon Research and Engineering Comany), P.O. Box 900, Annandale, NJ, 08801-0900, US

(21) Appl. No.: 09/750,364

(22) Filed: Dec. 5, 2000

(51) Int. Cl. B01J 21/12

(52) U.S. Cl. 502/177; 502/223; 502/261

(57) ABSTRACT

The present invention is a coated hydrogenation catalyst that includes a porous support material, an active metal component and a silica precursor, wherein the support material is impregnated with the active metal component and then contacted with the silica precursor. After impregnation, the support material is calcined to form a SiO₂ layer. The active metal component can be one or more Group VIII metals, metal oxides, metal sulfides or metal carbides. The support material for the coated catalyst is kieselguhr, alumina, silica or silica-alumina. In a preferred embodiment, the active metal component is platinum, palladium, rhodium, rhenium or iridium and the catalyst includes a zeolite component. The coated catalyst is prepared by first impregnating the support material with the active metal component and then contacting the silica precursor to form an impregnated catalyst. The impregnated catalyst is then calcined to form the coated catalyst having a SiO₂ layer. The impregnation with the active metal component and the incorporation of the silica precursor can be repeated two or more times to form a plurality of SiO₂ layers on the coated catalyst.

### BACKGROUND OF INVENTION

The present invention relates to coated catalysts that provide controlled dispersion and activity. In particular, the present invention relates to coated hydrogenation catalysts with selectivated activity formed by successive noble metal and silicone impregnations. These selective hydrogenation catalysts are especially useful for the controlled hydrogenation of specific components in a feedstock.

Hydrogenation is adding one or more hydrogen atoms to an unsaturated hydrocarbon (e.g., an olefin or aromatic compound). Hydrogenation can occur either as direct addition of hydrogen to the double bonds of unsaturated molecules, resulting in a saturated product, or it may cause breaking of the bonds of organic compounds, with subsequent reaction of hydrogen with the molecular fragments. Examples of the first type (called addition hydrogenation) are the conversion of aromatics to cycloparaffins and the hydrogenation of unsaturated vegetable oils to solid fats by addition of hydrogen to their double bonds. Examples of the second type (called hydrogenolysis or hydrocracking) are cracking of petroleum and hydrogenolysis of coal to hydrocarbon fuels.

The benefits of “purifying” petroleum fractions through hydrogen processing have been known since the early 1930's. However, because of a lack of cheap hydrogen and the high pressures formerly required, the process did not develop commercially until the middle 1950's. The advent of catalytic reforming, which made inexpensive hydrogen-rich off-gas available, encouraged hydrogen-processing development. Subsequent advances in catalyst technology allowed operating pressure requirements to be reduced. Today, hydrogenation is a well-established process both in the chemical and petroleum refining industries and is used extensively to prepare reformer feedstock and to some extent for catalytic cracking feedstock preparation. Product upgrading of middle distillates, cracked fractions, lube oils, gasolines, and waxes by means of hydrogen treating is also widespread. The process temperature and pressure for the treatment depends primarily upon properties of the feedstock and the desired products. Cracked stocks and heavy materials call for severe processing conditions (e.g., high pressure and long contact times).

Hydrogen treating is often justified for reasons other than the production of superior fuels. Hydrogenation improves yields; substantially eliminates waste-disposal problems caused by mercaptans, phenols, and thiophenols; and reduces corrosion problems from sulfur, cyanides and organic acids. Hydrogen treating also is important in sulfur recovery and subsequent reduction of air pollution by sulfur acid gases.

Hydrogenation is conventionally carried out in the presence of a catalyst that usually includes a metal hydrogenation component on a porous support material, such as a natural clay or a synthetic oxide. Nickel is often used as a hydrogenation component, as are noble metals such as platinum, palladium, rhodium and iridium. Typical support materials include kieselguhr, alumina, silica and silica-alumina. Depending upon the ease with which the feed may be hydrogenated, the hydrogen pressures that are used may vary from relatively low to very high values, typically hydrogen operating pressures are from about 100 to 2,500 psig (700 to 17,200 kPa).

A variety of organic compounds can be hydrogenated easily in the presence of a catalyst. Catalytic hydrogenation of olefins can be carried out either in gas or in liquid phase, depending on the olefin molecular weights. A nickel-containing catalyst or sometimes platinum or palladium catalysts are employed. Aromatic compounds may be reduced either in the vapor phase at atmospheric pressure or in the liquid phase at hydrogen pressures up to 200 atmospheres (2×10⁴ kilopascals). In the latter case, aromatics, such as benzene, toluene, and p-cymene, can be hydrogenated readily in the presence of a nickel catalyst. In the case of naphthalene or substituted naphthalenes, the product may be the tetra- or decahydronaphthalenes derivative.

Hydrogenation is an exothermic process and is generally favored thermodynamically by lower temperatures and by higher H₂ partial pressures. However, for practical reasons, moderately elevated temperatures are normally used and for petroleum refining processes, temperatures in the range of 100° to 700° F. are typical. Hydrogenative treatment is frequently used in petroleum refining to improve the qualities of lubricating oils, both of natural and synthetic origin. Hydrogenation, or hydrotreating, is used to reduce residual unsaturation in the lubricating oil, and to remove heteroatom-containing impurities and color bodies. The removal of impurities and color bodies is of particular significance for mineral oils that have been subjected to hydrocracking or catalytic dewaxing. For both hydroprocessed mineral and synthetic stocks, the saturation of lube boiling range olefins is a major objective.

It is often desirable to maximize the hydrogenation of one component in a hydrocarbon feedstock to produce a high yield of a particular product. This has led to a need for a hydrogenation catalyst with a controlled activity that has a high activity for certain components in a feedstock and a relatively low activity for the other components. Such controlled activity hydrogenation catalysts provide maximum yields of valuable products while at the same time minimizing the yields of less valuable products.

### SUMMARY OF THE INVENTION

In accordance with the present invention, a coated hydrogenation catalyst is provided. The coated hydrogenation catalyst includes a porous support material, an active metal component and a silica precursor. In a preferred embodiment, the support material is impregnated with the active metal component and then coated with the silica precursor. The silica precursor can be any source of silica, for example, a silicone compound. The ratio of ethylene hydrogenation activity to benzene hydrogenation activity (EHA:BHA) of the catalyst is higher than the EHA:BHA ratio of the same catalyst without the silica precursor coating. The coated catalyst is prepared by contacting the support material with the active metal component and the silica precursor and then calcining the catalyst to form a SiO₂ layer.

The active metal component can be one or more noble metals (or more generally, one or more Group VIII metal such as Ni or Co), metal oxides, metal sulfides, or metal carbides. Preferred active metal components are platinum, palladium, rhodium, rhenium or iridium metal, or the corresponding metal oxides, sulfides or carbides.

The binder material for the coated catalyst is kieselguhr, alumina, silica or silica-alumina. In a preferred embodiment, the active metal component of the coated catalyst is a noble metal and the catalyst includes a zeolite as a component. The coated catalyst is prepared by first impregnating the support material with the active metal component and then contacting it with a silica precursor (e.g., by impregnation or vapor deposition) to form an impregnated catalyst. The impregnated catalyst is then calcined to form the coated catalyst with a SiO₂ layer. In another embodiment of the present invention, the impregnation with the active metal component, subsequent contacting with a silica precursor and the calcination are repeated two or more times to form a coated catalyst with plurality of SiO₂ layers.

Prior to contacting the silica precursor, the metal containing catalyst has a benzene hydrogenation activity (BHA) level and an ethylene hydrogenation activity (EHA) level. The ethylene hydrogenation activity is defined as the first order rate constant for the hydrogenation of ethylene by the supported catalyst measured at atmospheric pressure and 50° C. Correspondingly, the benzene hydrogenation activity is defined as the first order rate constant for the hydrogenation of benzene at atmospheric pressure and 100° C. Both rate constants have dimensions of moles of hydrocarbon converted per mole of metal per second. After contacting the supported catalyst with the silica precursor, the BHA level of the noble metal decreases more than the EHA level on a percentage basis. In one embodiment, the ratio of EHA to BHA is greater than 50 and preferably greater than 100.

The present invention solves the need for a controlled activity hydrogenation catalyst by providing an impregnated catalyst that has a high activity for non-aromatic olefins and a low activity for benzene and other aromatics. The controlled dispersion and activity of the coated catalysts of the present invention permit the maximum production of valuable products and minimizes the production of less desirable byproducts.

### DETAILED DESCRIPTION OF THE INVENTION

The present invention is a hydrogenation catalyst having controlled dispersion and hydrogenation activity that can be used to selectively hydrogenate one or more components of a hydrocarbon feedstock. Platinum, rhenium and other noble metals combined with various oxide supports have been used for many hydrogenation processes. In these processes, the metals are typically added to the supports to saturate aromatic and/or olefinic species to mitigate aging. In some cases, this hydrogenation functionality needs to be very selective; such as when olefin saturation is desired, but aromatic saturation is not. For example, to prevent oversaturation of aromatics in gasoline by hydrotreating, the activity of a platinum catalyst can be modified by exposing the catalyst to steam. The steam environment causes the platinum to migrate and agglomerate into larger platinum particles which reduces its effectiveness. With essentially less platinum surface exposed, the platinum activity is decreased and is, therefore, more controllable. The other effect of steam, however, is to decrease the acid activity of the zeolite, as measured by Alpha. Depending upon the operating conditions, the steam can also cause structural damage and compromise the integrity of the zeolite pore structure.

As used herein, the Alpha value is an approximate indication of the catalytic cracking activity of the catalyst compared to a standard catalyst and it gives the relative rate constant (i.e., rate of normal hexane conversion per volume of catalyst per unit time). It is based on the activity of an amorphous silica-alumina cracking catalyst taken as an Alpha of 1 (Rate Constant =0.016 sec 1). The Alpha Test is described in U.S. Pat. No. 3,354,078 and in J. Catalysis 4:522-529 (August 1965): J. Catalysis 6:278 (1966); and J. Catalysis 61:395 (1980), each incorporated herein by reference as to that description. It is noted that intrinsic rate constants for many acid-catalyzed reactions are proportional to the Alpha value for a particular crystalline silicate catalyst (see “The Active Site Of Acidic Alumino-Silicate Catalysts,” Nature, 309(5959):589-591, (Jun. 14, 1984)). The Alpha value of the catalyst may be increased by treating the catalyst with nitric acid or by mild steaming as discussed in U.S. Pat. Nos. 3,257,310 and 4,326,994.

The present invention controls the activity of the active metal component in a catalyst by coating the catalyst with a silica precursor (e.g., a silicone compound). The term “coated catalyst” includes any catalyst treated with a silica precursor that affects the benzene hydrogenation activity of the active metal component. When the coated catalyst is used to treat a hydrocarbon feedstock, only selected components of the feedstock contact the active metal component and are hydrogenated. The components that react with the active metal component are determined by molecular size. It is believed that the smaller molecules, such as ethylene, can more easily access the metal through the silica coating, while larger molecules, such as benzene, have much more difficulty accessing the metal surface. Therefore, fewer of these molecules reach the active metal component.

The metal activities of the catalysts can be described in terms of two catalytic tests, an ethylene hydrogenation test (EHA) and a benzene hydrogenation test (BHA). The EHA test measures the activity of the catalyst in saturating olefins. The BHA test measures the activity of the catalyst in saturating aromatics. The ethylene hydrogenation test is run at atmospheric pressure over a fixed bed of catalyst at a hydrogen to ethylene ratio (molar) of 200:1, a weight hourly space velocity (WHSV) based on ethylene of 2000 hr⁻¹ and a temperature of 50° C. The benzene hydrogenation test is also run at atmospheric pressure at a hydrogen to benzene ratio (molar) of 200:1 and a weight hourly space velocity (WHSV) based on benzene of 500 hr⁻¹. The temperature is progressively raised from 50° C. to 75° C. to 100° C. and finally to 125° C. Conversion measurements are made at each temperature and an Arrhenius plot is constructed and used to determine the zero order rate constant at 100° C.

Prior to contacting the catalysts with either ethylene or benzene the catalysts are purged with helium at room temperature. After hydrogen is introduced, the temperature is raised to 110° C. and held for one hour, then raised to 250° C. and held for another hour to fully reduce the metal. After the catalyst cools to 25° C., the ethylene and hydrogen or benzene and hydrogen mixture is introduced.

The silica coating can be altered by the concentration of the silica precursor and the number of layers of silica coatings that are applied to the catalyst. A plurality of coating layers can be applied to further limit the reactivity of the higher molecular weight components.

The catalysts of the present invention have an active metal component, such as platinum anchored in a primarily siliceous environment, that can be modified in order to control its activity. The catalysts can use any of the zeolites used in hydrogenation catalysts to produce catalysts with anchored active metal components. The active metal component can be a noble metal or other metals, such a promoter, a modifier, a cation or a combination thereof. In addition to the noble metals, other metals such as nickel, cobalt, chromium, vanadium, molybdenum, tungsten, nickel-molybdenum, cobalt-nickel-molybdenum, nickel-tungsten, cobalt-molybdenum and nickel-tungsten-titanium can be used. The binder for the catalysts are conventionally a porous solid, usually alumina, or silica-alumina but other porous solids such as magnesia, titania or silica, either alone or mixed with alumina or silica-alumina may also be used, as convenient. Ideally, the catalysts also contain a zeolite as one of the components. The catalysts are formed before being contacted with the silica precursor (e.g., silicone or volatile silica compound).

The coated catalyst is prepared by first impregnating the support structure with an active metal component, such as platinum, and then anchoring the active metal component by contacting it with silicone. Silicone deposition after impregnation with the active metal component allows for the moderation or alteration of the metal dispersion and activity. The advantage of the finished catalyst is that it can be used as a catalyst with modified platinum activity without compromising the crystalline structure or acidity of the catalyst caused by alternative activity modification processes such as steaming. In addition, the benzene hydrogenation activity (BHA) for the coated catalysts is lower. However, the ethylene hydrogenation activity (EHA) is essentially unchanged because the active metal component is positioned in the support structure in locations that are inaccessible to benzene (or other aromatics), yet accessible to smaller, non-aromatic moieties such as olefins. This is advantageous, for example, in decreasing xylene loss while maintaining non-aromatic saturation and cracking in processes such as xylene isomerization.

A preferred embodiment of the present invention is a catalyst that has reduced benzene hydrogenation activity and high ethylene hydrogenation activity. This catalyst provides the advantage of controlled metal activity without the deleterious effects on acid activity or ethylene hydrogenation activity caused by other methods of attenuating hydrogenation activity such as steam modification.

In a preferred embodiment, the active metal component is incorporated into a catalyst via treatment of a zeolite crystal or a formed particle containing a zeolite by impregnation or ion exchange with a soluble form of the metal, e.g., a salt. In this context, the “active metal” may be a metal oxide, a metal sulfide, a metal carbide or apartially or fully reduced metal or a mixture of metals. Subsequently, the formed particle is treated with a silica precursor that deposits a thin layer of silica onto the formed particle in order to cover at least partially the metal component. In one preferred embodiment, a silicone polymer coats the catalyst and then is calcined to form a SiO₂ layer which coats the active metal component, particularly the active metal component outside of the zeolite crystal structure. The process of incorporating the silicone modifies the surface of the active metal component and decreases the accessible surface area of the active metal component as measured by hydrogen chemisorption. That is, the process decreases the amount of exposed active metal component. In addition, while the dispersion of the active metal component is decreased, the acid activity, as measured by Alpha, is not adversely affected. In essence, the catalyst formulation described herein produces a material with lower surface area for the active metal component and high Alpha.

The modification of the activity of the active metal component can be readily controlled by adjusting the parameters of the process, i.e., the formulation of the active metal component, the number of coatings applied and/or the amount (i.e., concentration) of silicone used in each coating. In this context, the “active metal” may be a metal oxide, a metal sulfide or a partially or fully reduced metal.

The silica precursor is preferably a liquid or a gas when it is incorporated into the catalyst particle. By changing the concentration in the silica precursor, different levels of metal activity and hydrogenation selectivity can be achieved. In addition, the amount of deposited silica can be changed to control the surface area of the exposed metal component.

When platinum is used as the active metal component in the catalyst, it has been discovered that platinum dispersion can be controlled by the extent of subsequent silicone impregnations. Therefore, it is possible to site platinum in locations that are inaccessible to benzene (or other aromatics) yet accessible to smaller molecules such as low molecular weight olefins. This advantageously decreases aromatic ring loss while maintaining non-aromatic saturation and cracking.

The benzene hydrogenation activity (BHA) test measures the platinum activity and typically correlates with platinum dispersion; that is, the higher the platinum dispersion, the more platinum surface is available and the higher the BHA activity. In the case of small and medium pore zeolites, BHA measures only the activity of platinum external to the zeolite since the size of the benzene molecule prevents it from saturating within the confines of the narrow pores (i.e., because of what is known as transition state selectivity). Benzene has a molecular diameter of roughly 6 Å or angstroms as determined by molecular orbital calculations. In the case of small and medium pore zeolites, BHA and platinum dispersion do not correlate. A poor correlation between BHA and platinum dispersion is also observed with the platinum-coated catalysts described herein. The BHA is lower than the value calculated using the measured platinum dispersions derived from hydrogen chemisorption measurements. This indicates that platinum is dispersed in regions of the support structure where the H₂ used in the platinum dispersion test can gain access, but the platinum is unavailable to the larger benzene molecules for benzene hydrogenation.

Ethylene hydrogenation activity (EHA) also measures platinum activity for saturating olefins. The ethylene hydrogenation activity of the catalysts of the present invention is relatively high compared to other noble metal, industrial hydrogenation catalysts. These results indicate that the platinum is situated in sites where ethylene can access it but benzene and other aromatics cannot. This provides the hydrogenation selectivity that can be tailored by the present invention. For example, in certain processes, it is desirable to saturate the non-aromatics but not the aromatics in a feedstock. The selectivity of the catalyst for reacting ethylene over benzene is expressed as the ratio of EHA to BHA (EHA/BHA). A higher ratio indicates that the catalyst saturates more non-aromatics than aromatics on a percentage basis.

The present invention was demonstrated using ZSM-5 catalyst suitable for xylene isomerization. The results from the examples are listed in Table 2. The Alpha activity measures the acidity of the resultant catalyst. Benzene hydrogenation activity (BHA) is a test that measures the hydrogenation activity of sites accessible to benzene. BHA is defined as moles of benzene converted per mole platinum per hour at 100° C. Ethylene hydrogenation activity (EHA) is a test that measures the hydrogenation activity of sites accessible to ethylene. EHA is defined as moles of ethylene converted/mole platinum per hour at 50° C. The selectivity of ethylene to benzene is described in the examples below as the ratio of EHA/BHA. For simplicity, the minimum BHA is assumed to be 0.1. The higher the EHA/BHA, the more selective the catalyst is for ethylene hydrogenation relative to benzene hydrogenation and, therefore, the more selective it will be towards saturating non-aromatics over aromatics.

### EXAMPLE 1

Selectivated Base Case Catalyst

Two hundred and fifty grams of a 65% ZSM-5/35% SiO2 1/16-inch diameter extrudate was impregnated with 25 grams of commercially available phenyl alkyl silicone four times with a calcination after each impregnation so as to produce a multiply silica ‘selectivated’ catalyst. Calcination conditions were 538 C. in flowing air for three hours in order to decompose the silica.

### EXAMPLE 2

Platinum Impregnation after Selectivation

One hundred grams of the catalyst of Example 1 was impregnated with a 0.1 wt % platinum tetraammine chloride hexahydrate solution by dissolving the salt in sufficient water to fill the pores of the catalyst to incipient wetness. The catalyst was impregnated in a double cone impregnator. After impregnation, the catalyst was dried for four hours at ambient conditions, dried at 250 F. overnight, and then calcined in fill air at 660 F. for three hours. The resulting Alpha value, platinum dispersion, and benzene hydrogenation (BHA) measurements are given in Table 2. The nominal Pt loading was 0.1 wt %.

### EXAMPLE 3

Steamed Platinum Impregnated Selectivated Catalyst

The catalyst described in Example 2 was steamed to decrease the platinum dispersion. One hundred and fifty grams of the catalyst was charged to a fixed bed steamer and heated to 900 F. in air at 5 F./minute. Steam was slowly introduced over the next ten minutes until it comprised 100% of the atmosphere. The temperature was then increased to 990 F. and held for three hours. The catalyst was cooled in flowing air before discharging. The resulting Alpha value, platinum dispersion, and benzene hydrogenation activity measurements are given in Table 2.

### EXAMPLE 4

Platinum Impregnation after Silica Selectivation

Four hundred grams of a second catalyst that had been previously silica selectivated as described in Example 1 was impregnated via the incipient wetness technique as described in Example 2 to produce an extrudate that contained 0.1 wt % Pt on a dry (ash) basis. Following impregnation, the catalyst was dried for four hours at ambient conditions, dried at 250 F. overnight, and then calcined in air at 660 F. for three hours. The resulting Alpha value, platinum dispersion, and benzene hydrogenation activity measurements are given in Table 2.

### EXAMPLE 5

Platinum Impregnation before Selectivation [High Alpha Case]

Two hundred gams of the same 65% ZSM-5/35% Al₂O₃ catalyst used to prepare the catalyst in Example 1 was impregnated via incipient wetness with a tetraammine platinum chloride hexahydrate solution to produce a catalyst containing 0.1 wt % Pt. Following impregnation, the catalyst was dried for four hours at ambient conditions, dried at 250 F. overnight, and then calcined in air at 660 F. for three hours. The resulting Alpha value, platinum dispersion, and benzene hydrogenation activity measurements are given in Table 2.

### EXAMPLES 6-9

Multiple Silicone Selectivations

The Pt/ZSM-5/Al₂O₃ catalyst described in Example 5 above was selectivated through four cycles with a silicone polymer using a standard incipient wetness, calcination procedure as follows. Catalyst was loaded into a rotating vessel equipped with a vacuum port for evacuation. A silicone in decane solution was prepared by dissolving the silicone polymer in decane to produce a viscous solution. The catalyst was impregnated via incipient wetness with the silicone-decane solution. Following impregnation, decane was removed by evaporation by pulling a vacuum on the vessel. After one hour, the vessel was allowed to fill with air and the catalyst was removed. The catalyst was allowed to dry overnight at room temperature. It was then calcined under nitrogen and thereafter under an air/nitrogen mixture at 1000 F. for a total of seven hours. This was repeated four times using the same lot of catalyst. Samples identified as Examples 6 through 9 were removed after each of the four cycles. The resulting Alpha value, platinum dispersion, and benzene hydrogenation activity measurements for each of these samples are given in Table 2.

### EXAMPLE 10

Steaming of Pt Impregnated then Selectivated Catalyst

The catalyst of Example 9 was steamed under the same conditions described in Example 3. The two resulting catalysts are compared below in Table

1. After steaming, the platinum impregnated then silica selectivated sample maintained a greater percentage of its original Alpha value. Moreover, its platinum dispersion did not diminish nearly as much as the unselectivated catalyst. This demonstrates that the silica selectivation preserved platinum dispersion while simultaneously preserving acidity, as measured by the Alpha test. More notable is the increase in the ratio of the Ethylene Hydrogenation Activity as compared to the Benzene Hydrogenation Activity (EHA/BHA ratio). This indicates that the catalyst has become much more selective for the hydrogenation of ethylene compared to hydrogenation of benzene following steaming. This is an important characteristic in processes such as para-xylene isomerization where preservation of the aromatic rings is critical.

TABLE 1
LOSSES AFTER STEAMING

| | | | Platinum | |
|---|---|---|---|---|
| | | Alpha | Dispersion | Change in |
| Example | Description | Losses | Losses | EHA/BHA |
| 1 and 2 | Steamed Standard | 82.5% | 75.4% | +30% |
| | Platinum-Impregnated | | | |
| | Catalyst | | | |
| 5 and 9 | Steamed | 21.7% | 45.7% | +500% |
| | Platinum-Coated Catalyst | | | |

### EXAMPLE 11

Platinum Impregnation Following 3 Cycle Silica Selectivation

A sample of the catalyst of Example 8 was impregnated via incipient wetness using the same procedure as described in Example 1 to produce a catalyst containing 0.1 wt % Pt. Following impregnation, the catalyst was dried for four hours at ambient conditions, dried at 250 F. overnight, and then calcined in air at 660 F. for three hours. The resulting Alpha value, platinum dispersion, and benzene hydrogenation activity measurements are given in Table 2. This Example serves to show that the Pt dispersion is virtually the same on a 3-cycle silica selectivated catalyst as it is on the base catalyst of Example 2.

### EXAMPLE 12

Effect of an Additional Silica Selectivation Cycle

The Pt impregnated catalyst described in Example 11 was selectivated one additional time using the same silicone polymer solution and procedure as described in Example 6. . Following impregnation, decane was removed by evaporation by pulling a vacuum on the vessel. After one hour, the vessel was allowed to fill with air and the catalyst was removed. The catalyst was allowed to dry overnight at room temperature. It was then calcined under nitrogen and then under an air/nitrogen mixture at 1000 F. for a total of seven hours. The resulting Alpha value, platinum dispersion, and benzene hydrogenation activity measurements are given in Table 2. This Example serves to demonstrate that the effect of the additional silica selectivation is to significantly diminish the benzene hydrogenation activity while only modestly affecting the ethylene hydrogenation activity.

TABLE 2

| Example | | | Pt Dispersion | BHA Activity | | | Δ(EHA/BHA) |
|---|---|---|---|---|---|---|---|
| No. | Catalyst Description | Alpha | H₂/Pt | (Minimum 0.1) | EHA | EHA/BHA | from Base |
| 2 | Pt on a 4× catalyst ⁽¹⁾ | 570 | 0.69 | 110 | 16100 | 146 | — |
| 3 | Steamed Pt/4× catalyst | 100 | 0.17 | 76 | 14700 | 193 | 30% |
| 4 | Pt on Standard 5× | 270 | 0.72 | 175 | — | — | — |
| 5 | Pt on ZSM-5/SiO₂ Base | 620 | 0.91 | 32.6 | 25400 | 779 | — |
| 6 | 1st Cycle Silicone Impregnation on Pt-Base | 460 | 0.35 | 24 | 15000 | 625 | 23% |
| 7 | 2nd Cycle Silicone Impregnation on Pt-Base | 560 | 0.21 | 12.0 | 13400 | 1117 | 119% |
| 8 | 3rd Cycle Silicone Impregnation on Pt-Base | 320 | 0.08 | 0.0 (0.1) | 3460 | 34600 | 6695% |
| 9 | 4th Cycle Silicone Impregnation on Pt-Base | 560 | 0.12 | 0.0 (0.1) | 17400 | 17400 | 3317% |
| 10 | Steamed Catalyst (same as Ex. 9) | 360 | 0.19 | 3.0 | 11500 | 3833 | 513% |
| 11 | 3× Catalyst + Pt | 520 | 0.72 | 95 | 19300 | 203 | — |
| 12 | 4× Catalyst w/Pt on 3× then Impregnated | 420 | 0.57 | 7.5 | 15500 | 2067 | — |

Notes:
⁽¹⁾ “×” defines the number of silica treatments, e.g., 4× denotes a 4 “times” selectivated catalyst.

As shown in Table 2, all of the catalysts prepared in accordance with the present invention are more selective for the hydrogenation of ethylene compared to benzene. Examples 9 and 10 show very low benzene hydrogenation activities (BHA), but relatively high ethylene hydrogenation activities (EHA). The acid activities, or alternatively, cracking activities of the catalysts, as determined by their Alpha values, are also very high. These catalysts would be expected to show excellent activity for xylene isomerization and produce very low xylene losses.

Thus, while there have been described the preferred embodiments of the present invention, those skilled in the art will realize that other embodiments can be made without departing from the spirit of the invention, and it is intended to include all such further modifications and changes as come within the true scope of the claims set forth herein.

What is claimed is:

1. A coated hydrogenation catalyst comprising a porous support material, an active metal component and a silica precursor, wherein the ratio of ethylene hydrogenation activity to benzene hydrogenation activity (EHA:BHA) of said catalyst is higher than the EHA:BHA ratio of the same catalyst without said silica precursor.

2. The coated catalyst according to claim 1, wherein said support material is contacted with said active metal component and said silica precursor and calcined to form a SiO₂ layer.

3. The coated catalyst according to claim 2, wherein said active metal component is one or more Group VIII metals, metal oxides, metal sulfides or metal carbides.

4. The coated catalyst according to claim 2, wherein said active metal component is platinum, palladium, rhodium, rhenium or iridium metal or corresponding metal oxides, sulfides or carbides.

5. The coated catalyst according to claim 2, wherein said binder material is kieselguhr, alumina, silica or silica-alumina.

6. The coated catalyst according to claim 2, wherein said active metal component is a noble metal and said catalyst also includes a zeolite as a component.

7. The coated catalyst according to claim 1, wherein said support material is first impregnated with said active metal component and subsequently contacted with said silica precursor to form an impregnated catalyst, and wherein said impregnated catalyst is calcined to form a SiO₂ layer.

8. The coated catalyst according to claim 1, wherein said support material is ion exchanged with said active metal component and subsequently contacted with said silica precursor to form an ion exchanged catalyst, and wherein said ion exchanged catalyst is calcined to form a SiO₂ layer.

9. The coated catalyst according to claim 7, wherein said impregnation with said active metal component, said subsequent contacting with said silica precursor and said calcination are repeated two or more times to form a plurality of SiO₂ layers.

10. The coated catalyst according to claim 9, wherein said active metal component is a noble metal and said catalyst also contains a zeolite.

11. The coated catalyst according to claim 10, wherein prior to contacting with said silica precursor, said noble metal has a benzene hydrogenation activity (BHA) level and a ethylene hydrogenation activity (EHA) level, and wherein after contacting with said silics precursor, the BHA level decreases more than the EHA level on a percentage basis.

12. The coated catalyst according to claim 11, wherein the ratio of EHA to BHA is greater than 100.
